(19) United States
(12) Patent Application Publication
(10) Pub. No.: US 2026/0289972 A1
(43) Pub. Date: Sep. 24, 2026

(54) ENHANCING AUTONOMOUS DRIVING SYSTEMS WITH EXTRACTED FEATURES FROM BIRD-EYE-VIEW DATA

(71) Applicant: Robert Bosch GmbH, Stuttgart (DE)

(72) Inventors: Feng TAO, Cupertino, CA (US); Xin YE, San Jose, CA (US); Burhaneddin YAMAN, San Jose, CA (US); Chenbin PAN, Syracuse, NY (US); Abhirup MALLIK, San Jose, CA (US); Liu REN, Saratoga, CA (US); Jingru LUO, Sunnyvale, CA (US)

(21) Appl. No.: 19/086,335

(22) Filed: Mar. 21, 2025

(51) Int. Cl. G06V 10/77; B60W 60/00; G06V 10/147; G06V 10/25; G06V 20/58

(52) U.S. Cl. CPC G06V 10/7715; B60W 60/00; G06V 10/147; G06V 10/25; G06V 20/58; B60W 2420/403; B60W 2420/408; B60W 2420/54; B60W 2554/4026; B60W 2554/4029

(57) ABSTRACT

The present disclosure pertains to methods and systems for improving autonomous driving systems by utilizing extracted features from bird-eye-view (BEV) data. The technical challenge addressed involves the less-than-optimal condition of models trained solely on limited autonomous datasets, which results in inconsistencies in BEV feature generation. The described approach offers a solution by integrating foundation models to align textual descriptions with BEV features extracted from alternative-imaging sensor data (e.g., LiDAR, RADAR). This integration provides additional supervision signals, enhancing the accuracy of BEV features and improving the system's ability to interpret the environment. In an autonomous vehicle setting, the system enhances the performance of downstream tasks like object detection and trajectory prediction without additional runtime costs. The method involves receiving alternative-imaging sensor data, executing a BEV extractor model, and backpropagating contrastive loss into the model to improve BEV feature data.

### TECHNICAL FIELD

The present disclosure relates to methods and systems for enhancing autonomous driving systems utilizing extracted features from birds-eye-view (BEV) data.

### BACKGROUND

An autonomous vehicle, often referred to as a self-driving or driverless vehicle, is a type of vehicle capable of navigating and operating on roads and in various environments without direct human control. Autonomous vehicles use a combination of advanced technologies and sensors to perceive their surroundings, make decisions, and execute driving tasks.

Autonomous vehicles are typically equipped with a variety of sensors, including lidar, radar, cameras, ultrasonic sensors, and sometimes additional technologies like GPS and IMUs (Inertial Measurement Units). These sensors provide real-time data about the vehicle's surroundings, including the positions of other vehicles, pedestrians, road signs, and road conditions. The vehicle's onboard computers use data from sensors to create a detailed map of the environment and to perceive objects and obstacles. This information is essential for navigation and collision avoidance.

Machine learning (ML) and artificial intelligence (AI) play a crucial role in autonomous vehicles. Deep learning algorithms are used for tasks like object detection, lane keeping, and decision-making, and can rely on image processing to perform these tasks. These algorithms enable the vehicle to understand and respond to complex and dynamic traffic situations.

### SUMMARY

In an embodiment, a method of enhancing an autonomous driving system utilizing extracted features from bird-eye-view (BEV) data comprises: receiving alternative-imaging sensor data associated with an environment about the vehicle, wherein the alternative-imaging sensor data is generated by an alternative-imaging sensor; executing a BEV extractor model to extract alternative-imaging BEV feature data based on the received alternative-imaging sensor data; generating bird eye view (BEV) based on the extracted alternative-imaging BEV feature data, wherein the BEV includes spatiotemporal information associated with detected agents in the environment; executing a BEV enhancement module to: (i) extract alternative-imaging BEV features associated with the detected agents in the environment, (ii) generate text information associated with the detected agents in the environment, (iii) execute a vision-language model (VLM) to extract text-based features from the generated text information, and (iv) execute a contrastive learning model to derive a contrastive loss between the alternative-imaging BEV features and the text-based features; and backpropogating the contrastive loss into the BEV extractor model to enhance the alternative-imaging BEV feature data.

In an embodiment, a system for enhancing an autonomous driving system utilizing extracted features from bird-eye-view (BEV) data comprises a processor programmed to: receive alternative-imaging sensor data associated with an environment about the vehicle, wherein the alternative-imaging sensor data is generated by an alternative-imaging sensor; execute a BEV extractor model to extract alternative-imaging BEV feature data based on the received alternative-imaging sensor data; generate bird eye view (BEV) based on the extracted alternative-imaging BEV feature data, wherein the BEV includes spatiotemporal information associated with detected agents in the environment; execute a BEV enhancement module to: (i) extract alternative-imaging BEV features associated with the detected agents in the environment, (ii) generate text information associated with the detected agents in the environment, (iii) execute a vision-language model (VLM) to extract text-based features from the generated text information, and (iv) execute a contrastive learning model to derive a contrastive loss between the alternative-imaging BEV features and the text-based features; and backpropogate the contrastive loss into the BEV extractor model to enhance the alternative-imaging BEV feature data.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3 shows a schematic diagram of a control system configured to control a vehicle, which may be a partially autonomous vehicle, a fully autonomous vehicle, a partially autonomous robot, or a fully autonomous robot, according to an embodiment.

FIG. 4 shows a schematic overview of a system for enhancing an autonomous driving system utilizing extracted BEV data, according to an embodiment.

FIG. 5 shows a schematic overview of a contrastive learning model, according to an embodiment.

FIG. 6 shows a schematic of a method enhancing an autonomous driving system utilizing extracted features from bird-eye-view (BEV) data, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In the context of autonomous vehicles, the term “agent” can refer to objects or entities in the environment that surrounds or interacts with the autonomous vehicle. This includes pedestrians, other vehicles, cyclists, road signs, traffic lights, lane lines, and the like. Objects or features that are being detected by the autonomous vehicle's sensors for use in decision making in controlling the autonomous vehicle can be collectively referred to as agents.

As will be explained in embodiments below, the present disclosure refers to “alternative-imaging,” such as an “alternative-imaging sensor” and associated “alternative-imaging sensor data” generated from those sensors. It should be understood that the term “alternative-imaging sensor data” is intended to refer to data captured from sensors that generate visual or spatial information without relying on traditional visible-light (RGB) cameras. These alternative-imaging sensors operate using wavelengths or modalities outside the visible spectrum or through non-optical means, providing insights that enhance or supplement visual data. Examples of such alternative-imaging sensors include lidar, radar, ultrasonic sensors, thermal imaging sensors, time-of-flight (ToF) sensors, millimeter-wave sensors, hyperspectral imaging, and the like. Another term to refer to alternative imaging sensor data can include, for example, non-optical sensor data, non-visual sensor data, supplemental imaging data, or alternative spectrum sensor data. Alternative imaging sensors do not include traditional RGB cameras in this disclosure, unless the context dictates otherwise. Alternative imaging sensors can also be referred to as non-camera image sensors.

Rapid advancements in autonomous driving technology have ushered in a new era of transportation, promising safer and more efficient journeys. Autonomous driving systems generally include three high-level tasks: (1) perception, (2) prediction, and (3) planning. Perception involves the vehicle's ability to understand and interpret its environment. This task includes various sub-components like computer vision, sensor fusion, and localization. Key elements of perception include object detection (e.g., identification and tracking agents external to the autonomous vehicle), localization (e.g., determining the vehicle's precise position and orientation in the world, often using GPS and other sensors), and sensor fusion (e.g., combining data from different sensors, such as cameras, lidar, radar, and ultrasonic sensors to build a comprehensive view of the surroundings). Prediction involves anticipating how other road users and agents in the environment will behave in the near future. This task often involves using machine learning models to estimate the trajectories and intentions of the agents, including pedestrians, other vehicles, and potential obstacles. Accurate prediction is crucial for making safe driving decisions. Planning involves determining the optimal path and actions for the autonomous vehicle to navigate its environment. This typically includes tasks like route planning, trajectory planning, and decision-making. The planning system considers information from perception and prediction to make decisions such as when to change lanes, when to stop at an intersection, how to react to unexpected events, and the like.

End-to-end autonomous driving systems have been proposed and gained interest in recent years. End-to-end autonomous driving systems unifies the perception, prediction, and planning tasks and performs joint optimization with a goal to facilitate and improve planning. A Bird's Eye View (BEV) serves as a main source of information for end-to-end autonomous driving systems. The BEV provides a top-down, holistic view of the surrounding environment, allowing the autonomous system to capture a comprehensive understanding of the scene. BEVs can be generated from different sensors such as cameras, LIDARs, and radars, etc. This view includes information about road layouts, lanes, intersections, and the positions of objects like vehicles, pedestrians, obstacles, and other agents. A detailed BEV view allows the system to identify potential collision risks, anticipate future actions, predict object trajectories, and plan safe and efficient routes. The information and feature space in BEV map is crucial for leading a smoother and more reliable driving.

However, traditional supervised learning methods, have only focused on aligning BEV representations with limited autonomous training data and task-specific supervision signals. When trained solely on sensor inputs with a constrained autonomous dataset, models tend to converge to suboptimal states. This can result in inconsistencies when compared to human common sense. In addition, while significant progress has been made in computer vision for autonomous driving, a crucial dimension has remained relatively unexplored: the fusion of language comprehension with BEV feature enhancement.

Foundation models, which are large pretrained machine learning models trained on open world data, often involve language as one of the main modalities of the data. In foundation models, there is usually connection between language and other modalities. After pretraining, the foundation models can be adapted to a given task via fine-tuning. Foundation models have shown importance of incorporating language in achieving state-of-the-art performance and generalization across wide variety of tasks.

Considering Foundation Models such as Large Language Models (LLMs) or Large Multi-Models (LMMs) capture a wide range of world knowledge, including common-sense reasoning and contextual awareness, leveraging this contextual knowledge to align the text description on ego vehicle surroundings with the BEV features extracted from different sensor data such as point clouds will provide extra supervision signals on BEV feature generation. This extra supervision can lead to more accurate BEV features that can enhance the system's ability in interpreting the environment.

Therefore, according to various aspects disclosed herein, the present disclosure presents a training strategy that integrates Foundation Models such as LLM to improve the content in BEV features for alternative-imaging sensors (e.g., LiDAR, RADAR and Ultra-sonic sensors). The enhanced BEV features are subsequently fed into downstream tasks, effectively boosting their performance. By leveraging foundation models during the training stage, this method provides a cost-effective and plug-in solution for existing data-driven autonomous driving pipelines. The proposed technique seamlessly integrates the comprehension capabilities of foundation models, such as LLMs or LMMs, to align textual descriptions with BEV features. This integration offers additional supervision signals, leading to more accurate BEV features that enhance the system's ability to interpret the environment. As a result, the approach significantly boosts the performance of downstream tasks, such as object detection and trajectory prediction, without incurring additional runtime costs.

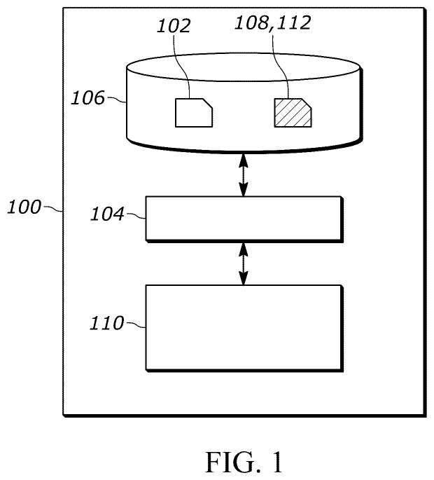

Machine learning and neural networks are an integral part of the inventions disclosed herein. FIG. 1 shows a system 100 for training a neural network, e.g. a deep neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106.

The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network; this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may, during or after the training, be replaced at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

The system 100 shown in FIG. 1 is one example of a system that may be utilized to train the machine learning models described herein.

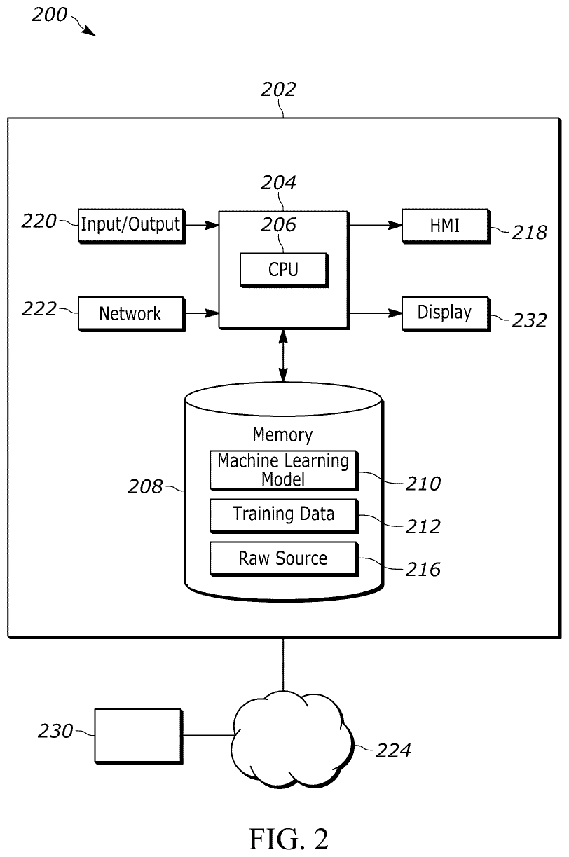

FIG. 2 depicts a system 200 to implement the machine-learning models described herein, for example the BEV extractor model, the BEV enhancement model, the VLM, the contrastive learning model, etc. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines, timing and counting facilities, and other structure known to provide such functions. Examples of input devices include a keyboard, mouse, sensors, touch screen, etc. Examples of output devices include monitors, touchscreens, speakers, head-up displays, vehicle control systems, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. The computing system 202 may include a display device 232. The computing system 202 may include hardware and software for outputting graphics and text information to the display device 232. The display device 232 may include an electronic display screen, projector, speaker or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The machine-learning algorithm(s) 210 may include algorithms configured to operate one or more of the machine learning models described herein, including the BEV extractor model, the BEV enhancement module, the VLM, the contrastive learning model, etc.

The computing system 202 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include input images that include an object (e.g., a street sign). These input images may be generated from a non-camera image sensor (e.g., radar, lidar, ultrasonic, etc.). The input images may include various scenarios in which the objects are identified. The training dataset 212 may also include the text description of the scene (e.g., “the pedestrian is crossing the street”) that corresponds to the images detected by the vehicle sensors.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data. In the context of the models described herein, a contrastive loss between the alternative-imaging BEV features and the text-based features can be determined and backpropogated into the BEV extractor model to enhance the alternative-imaging BEV feature data, as will be described below.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of agents in non-camera images, annotate the occurrences, and/or command the vehicle to take a specific action (planning) based on the locational data of the agent (perception) and the predicted future movement/location of the agent (prediction). The machine-learning algorithm 210 may be programmed to process the raw source data 216 to identify the presence of the particular features. The machine-learning algorithm 210 may be configured to identify a feature in the raw source data 216 as a predetermined feature (e.g., road sign, pedestrian, another vehicle, etc.). The raw source data 216 may be derived from a variety of sources. For example, the raw source data 216 may be actual input data collected by a machine-learning system. The raw source data 216 may be machine generated for testing the system. As an example, the raw source data 216 may include raw lidar images from a lidar sensor.

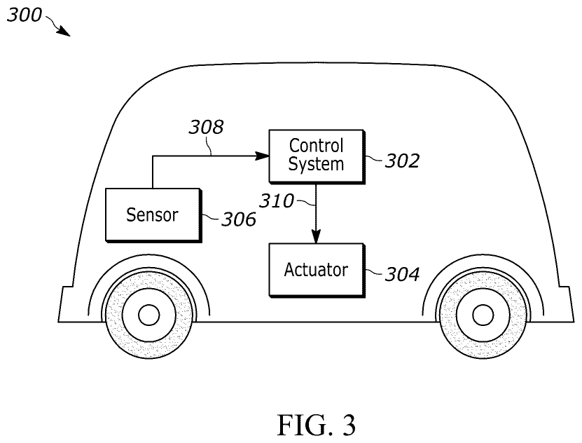

FIG. 3 depicts a schematic diagram of control system 302 configured to control vehicle 300, which may be a partially autonomous vehicle or fully autonomous vehicle, partially autonomous robot or fully autonomous robot. The vehicle 300 and/or its control system 302 can incorporate one or more components of the system 200, such as computing system 202 in order to issue commands 310 to an actuator 304 to perform a certain action based upon processing readings or data 308 from one or more sensors 306. For example, control system 302 can be configured to utilize the BEV extractor module disclosed herein in order to enhance the alternative-imaging BEV feature data that is ultimately used to control movement of the vehicle via actuator 304.

The one or more sensors 306 may include one or more image sensors (e.g., camera, video sensors, radar sensors, ultrasonic sensors, LiDAR sensors), and/or position sensors (e.g. GPS). The sensors 306 can be configured to generate raw source data 216. One or more of the one or more specific sensors may be integrated into vehicle 300. In the context of agent recognition and processing as described herein, the sensor 306 is an alternative-imaging sensor mounted to or integrated into the vehicle 300. Alternatively or in addition to one or more specific sensors identified above, sensor 306 may include a software module configured to, upon execution, determine a state of actuator 304.

In embodiments where vehicle 300 is a fully or partially autonomous vehicle, actuator 304 may be embodied in a brake, an accelerator, a propulsion system, an engine, a drivetrain, or a steering system (e.g., steering wheel) of vehicle 300. Actuator control commands may be determined such that actuator 304 is controlled such that vehicle 300 avoids collisions with detected agents, for example. Detected agents may also be classified according to what classifier deems them most likely to be, such as pedestrians or trees. The actuator control commands may be determined depending on the classification.

In other embodiments where vehicle 300 is a fully or partially autonomous robot, vehicle 300 may be a mobile robot that is configured to carry out one or more functions, such as flying, swimming, diving and stepping, via actuator 304. The mobile robot may be an at least partially autonomous lawn mower or an at least partially autonomous cleaning robot. In such embodiments, the actuator control command may be determined such that a propulsion unit, steering unit and/or brake unit of the mobile robot may be controlled such that the mobile robot may avoid collisions with identified objects.

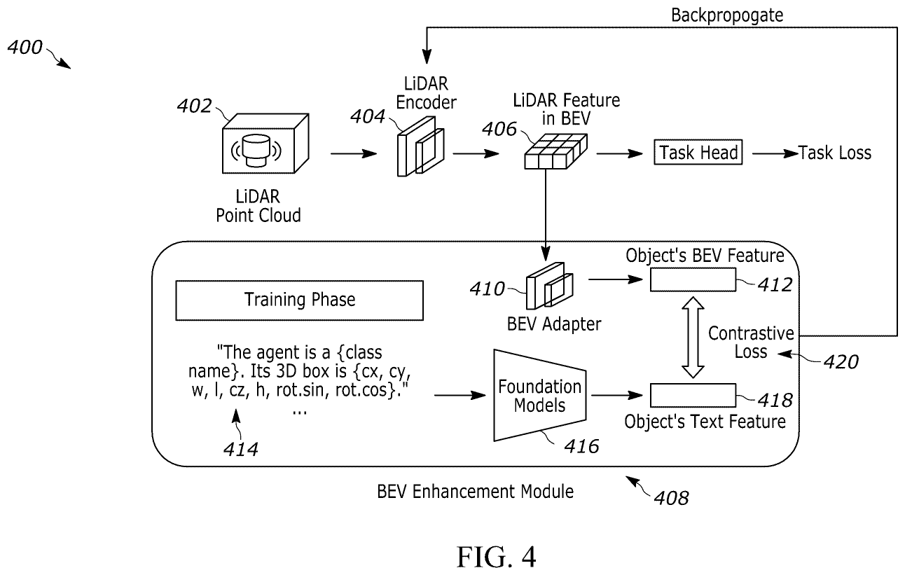

FIG. 4 illustrates a high-level overview of a BEV enhancement pipeline that leverages Foundation models (e.g., vision language models, VLMs) with a contrastive learning objective. Shown here is a system 400 for enhancing an autonomous driving system utilizing extracted BEV data, according to an embodiment. Ultimately, the pipeline shown herein can be merged or fused with other BEV data such as camera-based BEV data as part of an end-to-end system such as the one disclosed in U.S. patent application Ser. No. 18/388,606 titled SYSTEMS AND METHODS FOR VISION-LANGAUGE PLANNING (VLP) FOUNDATION MODELS FOR AUTONOMOUS DRIVING, filed Nov. 10, 2023, the end-to-end autonomous driving system of said application being incorporated herein.

Referring to FIG. 4, the system 400 begins with receiving alternative-imaging sensor data from an alternative-imaging sensor. The alternative-imaging sensor can be any of the alternative-imaging sensors described above, such as LiDAR, radar, ultrasonic, etc. In the illustrated embodiment, a LiDAR point cloud 402 serves as the initial data input. This point cloud represents the three-dimensional environment surrounding the vehicle. For example, the LiDAR point cloud data 402 can include a collection of 3D data points generated by a LiDAR sensor mounted on the vehicle, creating a detailed, three-dimensional picture of the surrounding environment by measuring the distance to various objects using laser pulses, with each point in the cloud representing a specific location in space with X, Y, and Z coordinates.

The system 400 also includes a BEV extractor model. In the illustrated embodiment, the BEV extractor model is a LiDAR encoder 404. The LiDAR encoder processes the LiDAR point cloud data 402 to extract relevant features. This encoder transforms the raw LiDAR data into a format suitable for further processing, e.g., LiDAR BEV features 406. In other words, the LiDAR encoder 404 extracts LiDAR BEV feature data 406 from the LiDAR point cloud data 402. Of course, the BEV extractor model can be another type of encoder configured for processing other types of alternative-imaging sensor data, and the disclosure is not limited to LiDAR data.

The BEV feature data at 406 is a representation of the environment in a bird's-eye view format and can include a variety of detailed representations of the environment surrounding the autonomous vehicle. Examples of these features include object detection and classification, which involves identifying and classifying objects such as vehicles, pedestrians, cyclists, and static obstacles, and determining their type and position relative to the vehicle. These features can also include road and lane detection maps the road layout, including lane markings, road edges, and intersections, aiding in understanding the vehicle's position on the road and planning its path. Three-dimensional bounding boxes are generated around detected objects to provide information about their size, orientation, and position in the environment. Surface and terrain mapping creates a detailed map of the terrain, including elevation changes, slopes, and surface types, crucial for navigating complex environments and ensuring vehicle stability. Dynamic object tracking monitors the movement of dynamic objects over time to predict their future positions and trajectories, essential for collision avoidance and safe navigation. Semantic segmentation assigns semantic labels to different regions in the BEV, such as road surfaces, sidewalks, vegetation, and buildings, providing context for decision-making. Obstacle detection and avoidance identify potential obstacles in the vehicle's path and determine safe routes to avoid them. These features collectively contribute to a comprehensive understanding of the vehicle's surroundings, enabling it to make informed decisions and navigate safely in various driving scenarios.

The LiDAR BEV features 406 are used for the downstream tasks such as detection and segmentation. The model comprising the LiDAR encoder followed by downstream task is trained in an end-to-end manner with an objective of minimizing downstream task loss. The training loss function can be defined by

$$Loss = L o s {s}_{task}$$

Lidar BEV feature map contains information about objects in the scene. Hence, the system 400 can obtain the corresponding features for each object during training. In order to supervise the generated BEV features for each object we apply ground truth language descriptions of each object to regularize the predicted object-level BEV features.

This is where the BEV enhancement module 408 comes into play. The BEV enhancement module 408 is a key component of the system, responsible for refining the BEV features. It operates during the training phase and leverages Foundation Models 416 (e.g., vision language models, VLMs) to enhance the BEV data.

In particular, according to embodiments, the BEV enhancement module 408 includes a BEV adapter 410 that acts upon the BEV feature data 406 to transform and adapt it for further processing stages. A primary function of the BEV adapter 410 is to take the raw or initial BEV features generated from the LiDAR data and enhance them to produce a more detailed and accurate representation of the environment. The BEV adapter may involve various computational techniques and algorithms to achieve this enhancement. It can include operations such as feature extraction, dimensionality reduction, noise filtering, and data fusion. By doing so, the BEV adapter 410 ensures that the resulting Object's BEV feature 412 is optimized for subsequent tasks, such as object detection, classification, and trajectory prediction. The BEV adapter 410 outputs the Object's BEV feature 412, which is a refined representation of the detected agents or objects in the environment.

In other words, in general, here the system 400 operates to extract alternative-imaging BEV features associated with the detected agents in the environment.

At 414, the BEV enhancement module generates text information associated with the detected agents in the environment. The BEV enhancement module can utilize advanced natural language processing techniques, such as LLMs or LMMs, to convert the raw training data into structured text. The system can formulate a text template for object-level descriptions. The sentences include the ground-truth of each object class and its corresponding 3D bounding box information, as in this phase such ground truth meta data is available as part of the training data. For example, the sentence for one object can be:
textobject=“This object is {a construction vehicle}. Its 3d bounding box is {cx, cy, w, l, cz, h, rotation}.”

Of course, the provided text template is just an example. The generated text can include detailed descriptions of the agents, such as their type (e.g., vehicle, pedestrian, cyclist), spatial attributes (e.g., position, orientation, size), and dynamic characteristics (e.g., speed, direction of movement). It can be altered and more information such as scene description can be added.

The text prompts are then forwarded through a Foundation Model 416, e.g., a VLM such as a Contrastive Language-Image Pretraining (CLIP) model. Other contrastive learning models can be employed. CLIP was developed by OpenAI. It is designed to understand and connect images and natural language descriptions in a way that allows it to perform a wide range of vision and language tasks. CLIP employs a dual-encoder architecture, comprising a vision encoder and a text encoder, and a shared embedding space. The vision encoder processes images, while the text encoder processes natural language descriptions. The vision encoder, based on a vision model like a convolutional neural network (CNN), converts images into a fixed-length vector representation. The text encoder processes textual descriptions by converting them into a fixed-length vector representation. CLIP is a vision-language foundation model trained on open world data using contrastive learning. Contrastive learning is a type of machine learning where the model learns to distinguish between positive and negative pairs of data. In the context of CLIP, the “positive pair” consists of an image and a text description that are semantically related, while the “negative pair” consists of an image and a randomly selected text description that is not related. During training, CLIP is designed to encourage bringing together features from related text and images pairs into a common embedding space, while pushing unrelated pairs apart.

CLIP's shared embedding space allows for zero-shot learning. When presented with an image and a text prompt, CLIP can rank how well the image matches the prompt without specific training data for that particular task. CLIP can perform various vision-language tasks, including image classification, text-based image retrieval (e.g., retrieving images based on textual queries), image captioning, zero-shot object recognition, and others.

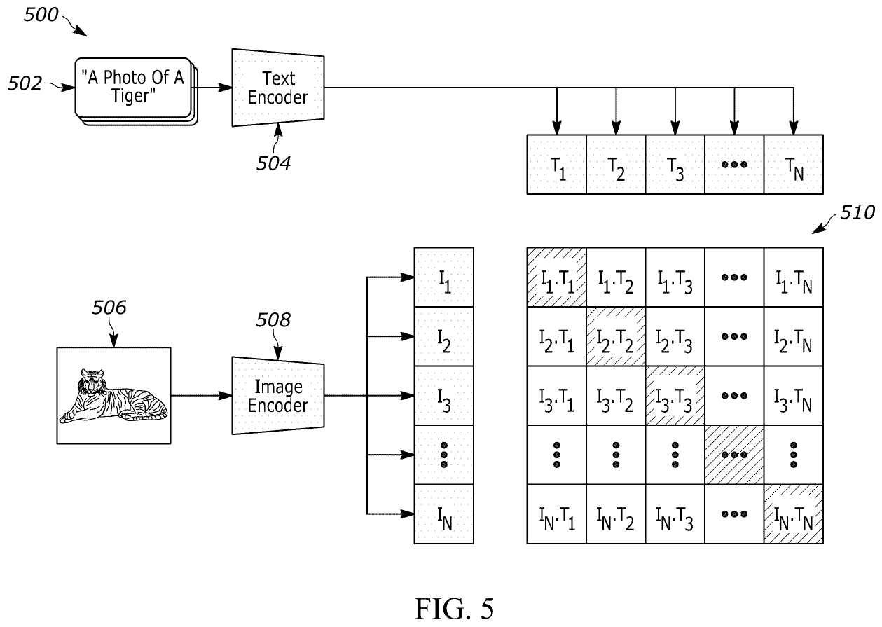

The contrastive learning concept used in CLIP (teachings of which are included in the VLP foundation model) is illustrated in FIG. 5, generally shown as a contrastive learning model at 500. As shown, a plurality of natural language text descriptions 502 are fed into a text encoder 504, and a plurality of images 506 are fed into an image encoder 508. The model 500 then performs feature mapping, where the vectors output by the encoders are mapped to a joint embedding space. For example, an image vector output by the image encoder (e.g., of a size 1×256) is matched to a corresponding text vector output by the text encoder (e.g., of a size 1×256). The model then performs a dot product between a batch of image and text features to get the similarity between these vectors, shown generally at 510

Referring to the example embodied in FIG. 5, a plurality of images 506 (one of which being an image of a tiger in this example) are fed into image encoder 508, and a plurality of text phrases 502 (one of which being something like “a photo of a tiger” in this example) is fed into text encoder 504. Several irrelevant or dissimilar text phrases and images are also fed into the encoders. For example, images of objects that are not tigers are fed into the image encoder 508, and phrases that have nothing to do with tigers are also fed into the text encoder 504. The image encoder produces an image vector having features I₁, I₂, . . . I_{N} while the text encoder produces a text vector having features T₁, T₂, . . . T_{N}. The diagonal of the resulting matrix 510 from this dot product shows paired image and text according to their likely similarity, while the off-diagonal represent unpaired image and text features (e.g., an image of a cat and a text description like “a picture of a dog”).

As such, the contrastive learning model brings the image and text embeddings closer together when they correspond to each other, and pushes them apart when they do not. In other words, referring to FIG. 5, during training, the contrastive learning model aims to increase the similarity of diagonal elements (i.e. positive pairs), while decreasing the similarity between off-diagonal elements. As another example, during training, if the model is provided with an image of a cat and a text description like “a picture of a cat”), the model aims to minimize the distance (similarity) between the image and text embeddings in the shared space; conversely, if the model is provided with an image of a cat and a text description like “a picture of a dog,” the model aims to maximize the distance (dissimilarity) between their embeddings. This contrastive training objective encourages the model to learn to understand the semantic relationships between images and text. It is a way to teach the model to associate matching image-text pairs closely and distinguish non-matching pairs effectively. The result is a shared embedding space where similar pairs cluster together, and dissimilar pairs are far apart.

Returning to FIG. 4, the Foundation Model (e.g., CLIP) is executed at 416 to extract text-based features 418 from the generated text 414. In an embodiment, the contrastive learning model such as CLIP includes its own sub-model that can extract text-based features 418 from the generated text 414. The execution of the foundation model 416, specifically a model like CLIP, to extract the object's text-based features 418 from the generated text 412 can involve a sophisticated process of integrating natural language understanding with visual feature alignment. Initially, the generated text 412, which provides detailed descriptions of the detected agents in the environment, is input into the foundation model 416. This model 416 is pre-trained on extensive datasets to effectively understand and process natural language in conjunction with visual data. The foundation model analyzes the input text 414 to identify key semantic elements and contextual information relevant to the detected objects. It then transforms this textual data into a set of text-based features 418, which encapsulate the semantic essence of the descriptions. These features are designed to align with the visual features 414 extracted from the BEV data, facilitating a comprehensive understanding of the environment.

Subsequently, as illustrated at 420, the BEV enhancement module executes a contrastive learning model to perform contrastive learning between the object's text features 418 and object's BEV features 412 to align them. This process involves the simultaneous processing of both feature sets to identify and maximize their mutual information. By leveraging contrastive learning, the model aims to bring the text-based and BEV features closer in the feature space when they correspond to the same object, while pushing apart features that do not match. This alignment is achieved by calculating a contrastive loss, which quantifies the discrepancy between the two feature sets. The contrastive loss (Loss_{contra}) is included as an additional loss in the training process. Therefore, the process can be represented as follows:

$$Loss = {Loss}_{task} + L o s {s}_{contra}$$

The loss function is designed to minimize the distance between matching pairs of text and BEV features, thereby enhancing the semantic accuracy of the BEV data. Through iterative training, the contrastive learning mechanism refines the feature representations, ensuring that the textual descriptions and visual data are harmoniously aligned.

The contrastive loss can then be backpropogated into the BEV extractor model to enhance the LiDAR BEV feature 406. The contrastive loss is used to update the parameters of the BEV extractor model. The backpropagation algorithm is employed to propagate the error signal, represented by the contrastive loss, backward through the network layers of the BEV extractor model. During this process, the model's weights are adjusted to minimize the loss, effectively improving the alignment between the text and BEV features. This iterative adjustment refines the feature extraction process, enabling the BEV extractor model to generate more accurate and semantically enriched LiDAR BEV features. By continuously optimizing the model parameters through backpropagation, the system enhances its ability to interpret the environment, leading to improved performance in tasks such as object detection, classification, and trajectory prediction. This approach ensures that the LiDAR BEV features are not only visually precise but also semantically aligned with the textual descriptions, providing a robust foundation for autonomous driving applications.

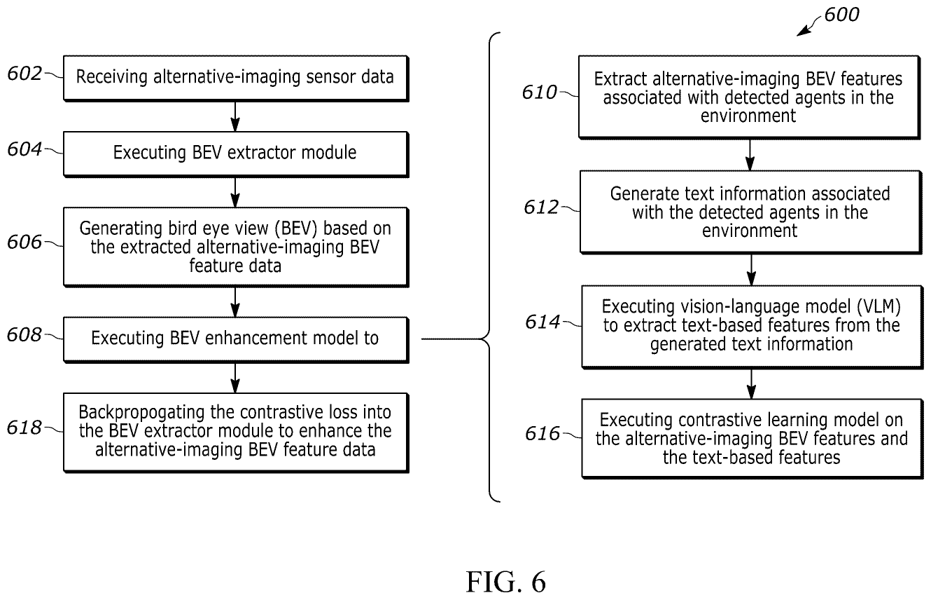

FIG. 6 illustrates a method 600 of enhancing an autonomous driving system utilizing extracted features from BEV data, according to an embodiment. At 602, the method includes receiving alternative-imaging sensor data. This can be LiDAR data, ultrasonic data, radar data, or other non-camera based image data described herein. The data can be generated live or provided from a training database.

At 604, the method includes executing a BEV extractor model to extract alternative-imaging BEV feature data based on the received alternative-imaging sensor data. The BEV extractor model can be, for example, a LiDAR encoder such as illustrated at 404.

At 606, the method includes generating a BEV based on the extracted alternative-imaging BEV feature data. The BEV includes spatiotemporal information associated with detected agents in the environment. The BEV can include other information such as described above regarding the detected agents in the environment.

At 608, the method includes executing a BEV enhancement module. The BEV enhancement module is a group of ML models configured to prepare the data for contrastive learning techniques and backpropogation for enhancement. For example, at 610, the BEV enhancement module is executed to extract alternative-imaging BEV features associated with the detected agents in the environment (e.g., see 410 above). At 612, the BEV enhancement module is executed to generate text information associated with the detected agents in the environment (e.g., see 414 above). At 614, the BEV enhancement module causes execution of a vision-language model (VLM, CLIP) to extract text-based features 418 from the generated text information. At 616, the BEV enhancement module executes a contrastive learning model to derive a contrastive loss between the alternative-imaging BEV features and the text-based features. The contrastive learning model can be part of CLIP, for example, while a sub-model within CLIP is responsible for the extraction of text-based features.

At 618, the method includes backpropogating the contrastive loss into the BEV extractor module to enhance the alternative-imaging BEV feature data.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of enhancing an autonomous driving system utilizing extracted features from bird-eye-view (BEV) data, the method comprising:
receiving alternative-imaging sensor data associated with an environment about the vehicle, wherein the alternative-imaging sensor data is generated by an alternative-imaging sensor;
executing a BEV extractor model to extract alternative-imaging BEV feature data based on the received alternative-imaging sensor data;
generating bird eye view (BEV) based on the extracted alternative-imaging BEV feature data, wherein the BEV includes spatiotemporal information associated with detected agents in the environment;
executing a BEV enhancement module to:
(i) extract alternative-imaging BEV features associated with the detected agents in the environment,
(ii) generate text information associated with the detected agents in the environment,
(iii) execute a vision-language model (VLM) to extract text-based features from the generated text information, and
(iv) execute a contrastive learning model to derive a contrastive loss between the alternative-imaging BEV features and the text-based features; and
backpropogating the contrastive loss into the BEV extractor model to enhance the alternative-imaging BEV feature data.

2. The method of claim 1, wherein the extracted alternative-imaging BEV feature data includes bounding box data associated with the detected agents.

3. The method of claim 1, further comprising repeating the steps of executing the BEV enhancement module and backpropogating until convergence to minimize loss.

4. The method of claim 1, wherein the alternative-imaging sensor includes at least one of a LiDAR sensor, radar sensor, and ultrasonic sensor.

5. The method of claim 1, wherein the BEV enhancement module employs a large language model (LLM) or large multi-model (LMM) to generate the text information.

6. The method of claim 1, wherein the contrastive learning model is further configured to push apart dissimilarities between the alternative-imaging BEV features and the text-based features.

7. The method of claim 1, wherein the agents in the environment include at least one of a pedestrian, another vehicle, or a cyclist.

8. A system for enhancing an autonomous driving system utilizing extracted features from bird-eye-view (BEV) data, the system comprising:
a processor programmed to:
receive alternative-imaging sensor data associated with an environment about the vehicle, wherein the alternative-imaging sensor data is generated by an alternative-imaging sensor;
execute a BEV extractor model to extract alternative-imaging BEV feature data based on the received alternative-imaging sensor data;
generate bird eye view (BEV) based on the extracted alternative-imaging BEV feature data, wherein the BEV includes spatiotemporal information associated with detected agents in the environment;
execute a BEV enhancement module to:
(i) extract alternative-imaging BEV features associated with the detected agents in the environment,
(ii) generate text information associated with the detected agents in the environment,
(iii) execute a vision-language model (VLM) to extract text-based features from the generated text information, and
(iv) execute a contrastive learning model to derive a contrastive loss between the alternative-imaging BEV features and the text-based features; and
backpropogate the contrastive loss into the BEV extractor model to enhance the alternative-imaging BEV feature data.

9. The system of claim 8, wherein the extracted alternative-imaging BEV feature data includes bounding box data associated with the detected agents.

10. The system of claim 8, wherein the processor is further programmed to repeat the execution of the BEV enhancement module and backpropogating until convergence to minimize loss.

11. The system of claim 8, wherein the alternative-imaging sensor includes at least one of a LiDAR sensor, radar sensor, and ultrasonic sensor.

12. The system of claim 8, wherein the BEV enhancement module employs a large language model (LLM) or large multi-model (LMM) to generate the text information.

13. The system of claim 8, wherein the contrastive learning model is further configured to push apart dissimilarities between the alternative-imaging BEV features and the text-based features.

14. The system of claim 8, wherein the agents in the environment include at least one of a pedestrian, another vehicle, or a cyclist.

15. A method of enhancing an autonomous driving system utilizing extracted features from bird-eye-view (BEV) data, the method comprising:
receiving alternative-imaging sensor data associated with an environment about the vehicle, wherein the alternative-imaging sensor data is generated by an alternative-imaging sensor;
extracting alternative-imaging BEV feature data based on the received alternative-imaging sensor data;
generating bird eye view (BEV) based on the extracted alternative-imaging BEV feature data, wherein the BEV includes spatiotemporal information associated with detected agents in the environment;
extracting alternative-imaging BEV features associated with the detected agents in the environment;
executing a large language model (LLM) to generate text information associated with the detected agents in the environment;
executing a vision-language model (VLM) to extract text-based features from the generated text information;
executing a contrastive learning model to derive a contrastive loss between the alternative-imaging BEV features and the text-based features; and
backpropogating the contrastive loss into the BEV extractor model to enhance the alternative-imaging BEV feature data.

16. The method of claim 15, wherein the extracted alternative-imaging BEV feature data includes bounding box data associated with the detected agents.

17. The method of claim 15, further comprising repeating the steps of executing the BEV enhancement module and backpropogating until convergence to minimize loss.

18. The method of claim 15, wherein the alternative-imaging sensor includes at least one of a LiDAR sensor, radar sensor, and ultrasonic sensor.

19. The method of claim 15, wherein the BEV enhancement module employs a large language model (LLM) or large multi-model (LMM) to generate the text information.

20. The method of claim 15, wherein the contrastive learning model is further configured to push apart dissimilarities between the alternative-imaging BEV features and the text-based features.
